(19) United States
(12) Patent Application Publication
(10) Pub. No.: US 2010/0270791 A1
(43) Pub. Date: Oct. 28, 2010

(54) SAFETY LOCKING DEVICE FOR PIPE CONNECTOR

(76) Inventor: Shen-Chih Lee, Taipei (TW)

Correspondence Address: PAI PATENT & TRADEMARK LAW FIRM, 1001 FOURTH AVENUE, SUITE 3200, SEATTLE, WA, 98154, US

(21) Appl. No.: 12/430,899

(22) Filed: Apr. 28, 2009

(51) Int. Cl. F16L 55/00

(52) U.S. Cl. 285/85

(57) ABSTRACT

A safety locking device includes a locking lever pivotally connected to a pipe connector for locking a connection member to the pipe connector, a retaining plate pivotally connected to the pipe connector for stopping the locking lever in the locking position, a lock pin axially movably inserted through a longitudinal through hole on a protruding block of the locking lever for engagement with the retaining plate to stop the retaining plate and the locking lever in position, a spring member mounted in the longitudinal through hole to force the lock pin into engagement with the retaining plate, and a pull ring connected to the bottom end of the lock pin for a user to pull to disengage the lock pin from the retaining plate and to further unlock the retaining plate and the locking lever.

### BACKGROUND OF THE INVENTION

(a) Field of the Invention

The present invention relates to pipe connectors and more particularly to a safety locking device for pipe connector, which effectively locks the locking lever in the locking position, assuring a high level of safety.

(b) Description of the Prior Art

Pipe connectors are intensively used in fluid delivery facilities for quick connection of a connection member of a piping system for delivery of oil or other fluids. A conventional pipe connector, as shown in FIG. 1, comprises a pipe connector body 10 having two pairs of lugs 20 at two sides and two openings 30 corresponding to the lugs 20, and two locking levers 40 respectively pivotally connected to the lugs 20 of the pipe connector body 10. Each locking lever 40 has a cam portion 401 inserted through the adjacent opening 30 for locking the inserted connection member 50 to the pipe connector body 10. This design of pipe connector is not safe in use. When the piping system is being pulled on the floor or when a person or machine accidentally touches the locking lever 40, the locking lever 40 may be unlocked.

To avoid the aforesaid problem, an improved design was created. According to this design, as shown in FIG. 2, the pipe connector body 10 has an integral locating block 60 and a locating groove 601 on the bottom side of the locating block 60; a lock pin 70 is mounted in the locking lever 40 and supported on a spring member (not shown) for engaging the locating groove 601 to hold the locking lever 40 in the locking position, having a rear end connected with a pull ring 80. When the pull ring 80 is pulled to disengage the lock pin 70 from the locating groove 601, the locking lever 40 is released from the constraint and can be biased from the locking position to the unlocking position.

The aforesaid improved pipe connector structure avoids accidental unlocking of the locking lever 40, however, the pipe connector body 10 having the said locating block 60 with the said locating groove 601 formed therewith integrally (by casting) is a specially designed structure. In order to use this design of improved pipe connector structure, existing pipe connectors must be replaced. The cost for replacing existing pipe connectors is high. Further, the pull ring 80 is inserted through the bottom end of the lock pin 70 and the rectangular slot 401 of the locking lever 40. When the pull ring 80 is turned accidentally by an external force, the pull ring 80 will be stopped at the top edge of the rectangular slot 401 and the lock pin 70 will be pulled downwardly away from the locating groove 601, thereby loosening the safety locking.

### SUMMARY OF THE INVENTION

The present invention has been accomplished under the circumstances in view. It is one object of the present invention to provide a safety locking device for pipe connector, which is suitable for use in any of a variety of conventional pipe connectors to assure a high level of locking safety. It is another object of the present invention to provide a safety locking device for pipe connector, which avoids accidental biasing of the pull ring after locking of the locking lever, assuring a high level of safety.

To achieve these and other objects of the present invention, the safety locking device comprises a locking lever pivotally connected to a pipe connector for locking a connection member to the pipe connector, a retaining plate pivotally connected to the pipe connector for stopping the locking lever in the locking position, a lock pin axially movably inserted through a longitudinal through hole on a protruding block of the locking lever for engagement with the retaining plate to stop the retaining plate and the locking lever in position, a spring member mounted in the longitudinal through hole to force the lock pin into engagement with the retaining plate, and a pull ring inserted through rectangular slots on the protruding block of the locking lever and connected to the bottom end of the lock pin for a user to pull in order to disengage the lock pin from the retaining plate and to further unlock the retaining plate and the locking lever.

Further, each pull ring slot has a narrow extension slot portion vertically upwardly extended from the top end thereof for receiving the pull ring in order to prevent accidental biasing of the pull ring by an external force.

### BRIEF DESCRIPTION OF THE DRAWINGS

FIG. 1 is a schematic drawing of a pipe connector according to the prior art.

FIG. 2 is a schematic drawing of another structure of pipe connector according to the prior art.

FIG. 3 is an exploded view of a safety locking device for pipe connector according to the present invention.

FIG. 4 is an exploded view of a pipe connector embodying the present invention.

FIG. 5 is an elevational assembly view of FIG. 4.

FIG. 6 is a sectional side view of FIG. 5

FIG. 7 corresponds to FIG. 6, showing a connection member inserted into the pipe connector and locked.

FIG. 8 corresponds to FIG. 7, showing the lock pin disengaged from the retaining plate.

FIG. 9 corresponds to FIG. 8, showing the locking levers of the two safety locking devices turned to the respective unlocking positions and the connection member removed from the pipe connector.

FIG. 10 is an exploded view of an alternate form of the safety locking device for pipe connector according to the present invention.

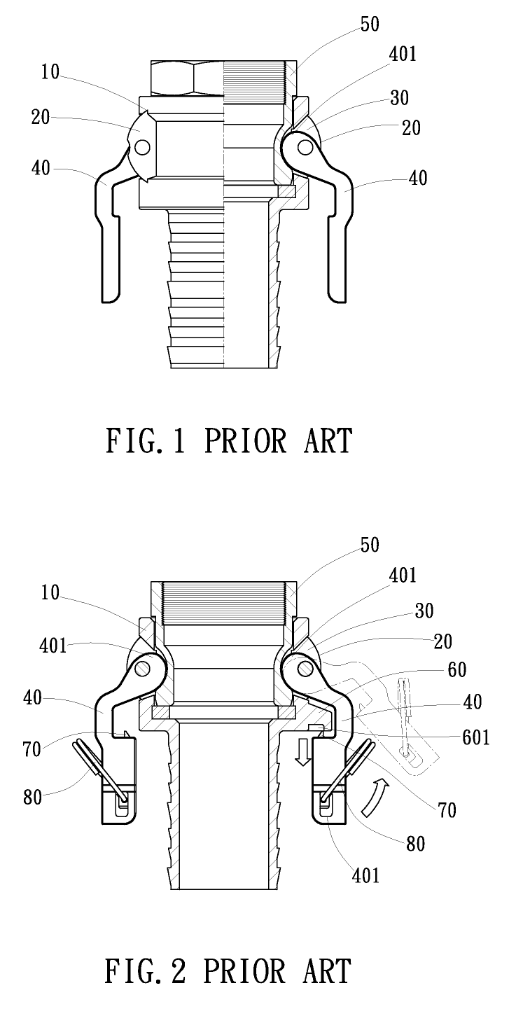

### DETAILED DESCRIPTION OF THE PREFERRED EMBODIMENTS

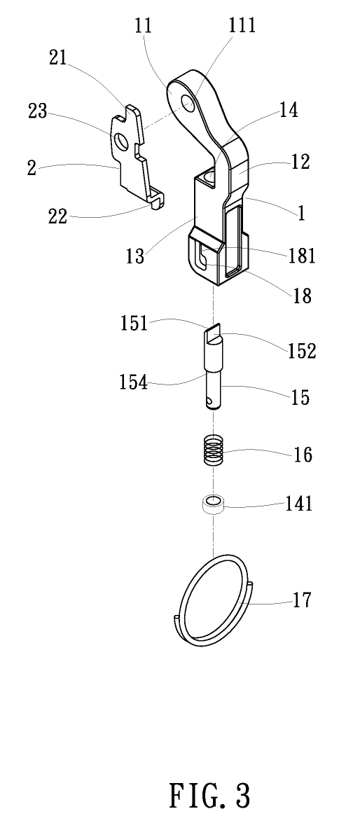

Referring to FIGS. 3˜6, a safety locking device is shown installed in a pipe connector 3, comprising a locking lever 1 and a retaining plate 2.

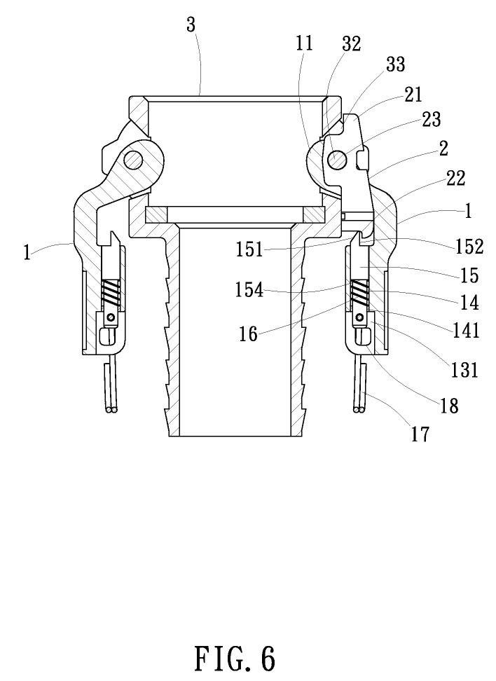

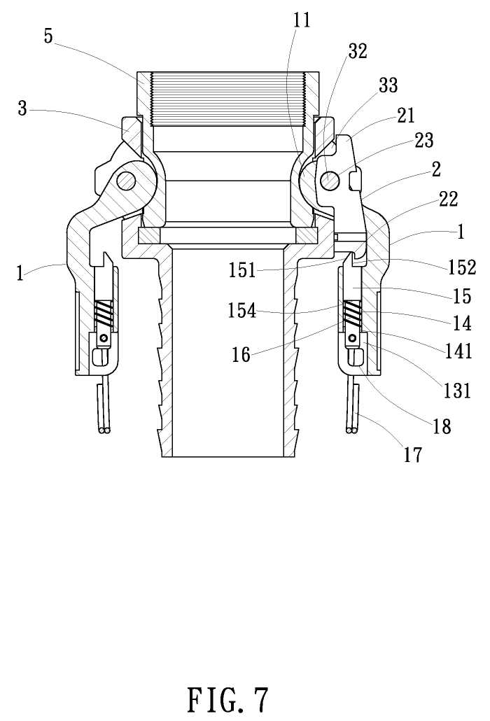

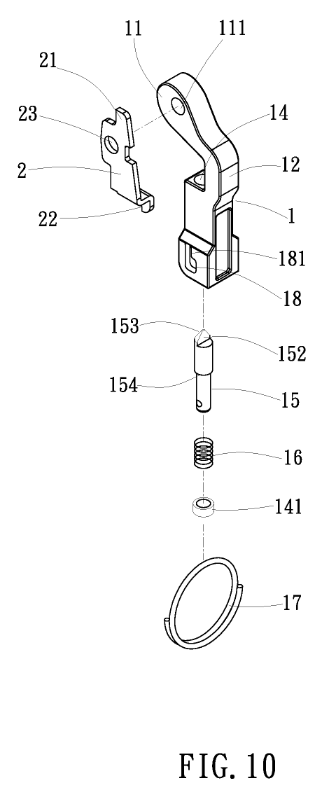

The locking lever 1, as shown in FIGS. 3 and 6, has a rounded engagement portion 11 located on its one end, a pivot hole 111 transversely cut through the rounded engagement portion 11 and pivotally connected to the pipe connector 3, a grip 12 located on its other end, a protruding block 13 integrally formed with an inner side of the grip 12, and a longitudinal through hole 14 cut through the top and bottom ends of the protruding block 13. A lock pin 15 is axially movably inserted into the longitudinal through hole 14. The lock pin 15 has a beveled front edge 151, and an angled notch 152 disposed at one side relative to the beveled front edge 151. Alternatively, as shown in FIG. 10, the lock pin 15 can be made having a front conical tip 153, and an angled notch 152 disposed at one side relative to the front conical tip 153. Further, a spring member 16 is mounted in the longitudinal through hole 14 and adapted to impart an upward pressure to the lock pin 15, holding the lock pin 15 in a position where the beveled front edge 151 protrudes over the topmost edge of the protruding block 13. Further, a pull ring 17 is connected to the bottom end of the lock pin 15 for a user to pull in order to retract the lock pin 15.

The lock pin 15 further has a step 154 near its front end. A stop ring 141 is sleeved onto the bottom end of the lock pin 15 and affixed to the bottom end of the longitudinal through hole 14. The spring member 16 can be a spiral compression spring sleeved onto the lock pin 15 and stopped between the step 154 of the lock pin 15 and the stop ring 141 at the bottom end of the longitudinal through hole 14. Therefore, the spring member 16 immediately returns the lock pin 15 to its former position after the lock pin 15 is pulled and released. The locking lever 1 further has a recess 131 located on the bottom side of the protruding block 13, and two pull ring slots 18 symmetrically disposed at two opposite lateral sides of the recess 131. The bottom end of the lock pin 15 suspends in the recess 131. The pull ring 17 has a part thereof inserted through the pull ring slots 18 and coupled to the bottom end of the lock pin 15. Each of the pull ring slots 18 has a rectangular portion, and a narrow extension slot portion 181 vertically upwardly extended from the top end of the rectangular portion. When the pull ring 17 is set in the narrow extension slot portions 181 of the pull ring slots 18, the pull ring 17 can simply be pulled vertically downwards but is prohibited from being turned to any other direction.

The retaining plate 2, as shown in FIGS. 3 and 6, can be stamped from a metal sheet material or injection-molded from plastics. The retaining plate 2 has a top protrusion 21, a bottom engagement portion 22 for engagement with the lock pin 15, and a pivot hole 23 on the middle corresponding to the pivot hole 111 of the locking lever 1.

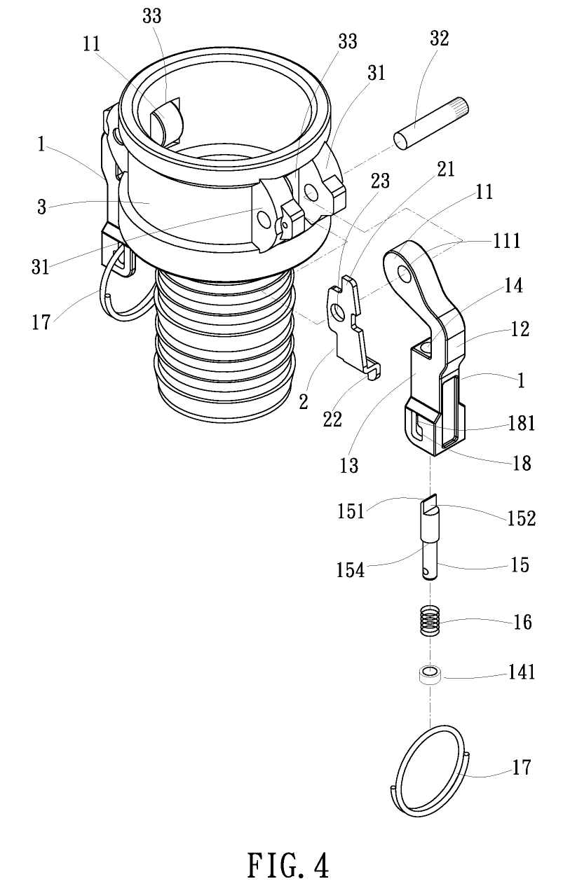

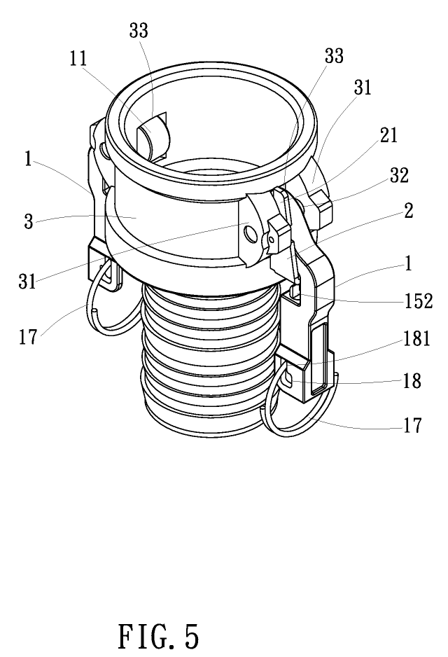

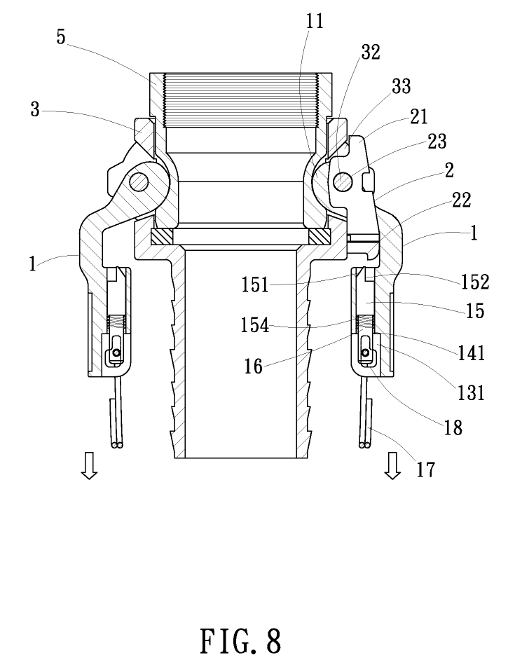

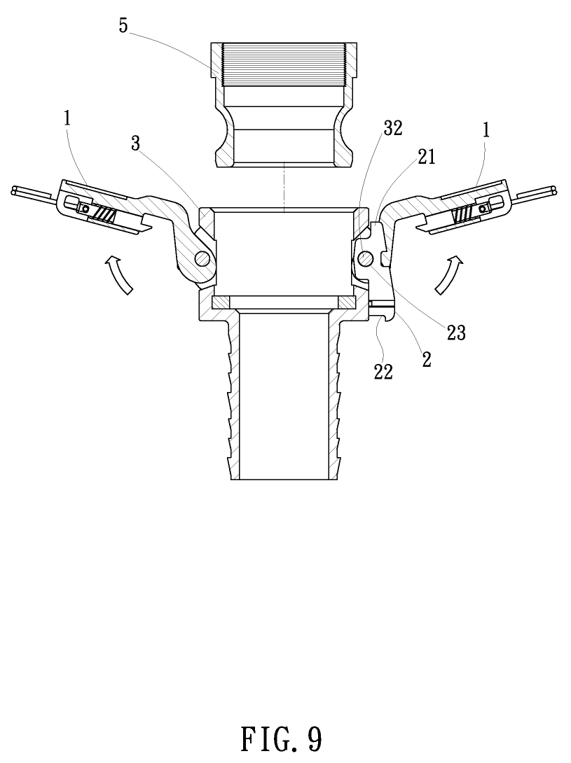

When the safety locking device is applied, as shown in FIGS. 4˜7, a pivot pin 32 is inserted through the pivot hole 111 of the locking lever 1 and the pivot hole 23 of the retaining plate 2 to pivotally connect the locking lever 1 and the retaining plate 2 between two parallel lugs 31 of the pipe connector 3, allowing the rounded engagement portion 11 of the locking lever 1 to be forced through an opening 33 on the peripheral wall of the pipe connector 3 into engagement with a connection member 5 to lock the connection member 5 to the pipe connector 3. The retaining plate 2 is attached to one side of the locking lever 1. The top protrusion 21 is stopped against the top edge of the opening 33 to prohibit the retaining plate 2 from biasing. The bottom engagement portion 22 of the retaining plate 2 is adapted for engagement with the front end of the lock pin 15 to prohibit the locking lever 1 from being turned outwards from the locking position toward the unlocking position, assuring a high level of safety. Further, as shown in FIGS. 8 and 9, in order to disconnect the pipe connector 3 from the connection member 5, pull the pull ring 17 to retract the lock pin 15 and to further disengage the front end of the lock pin 15 from the bottom engagement portion 22 of the retaining plate 2, and then turn the locking lever 1 outwards relative to the pipe connector 3 and the retaining plate 2 to disengage the rounded engagement portion 11 from the connection member 5. Thus, the pipe connector 3 is unlocked from the connection member 5.

In conclusion, the invention has the advantages as follows: The locking lever 1 and the retaining plate 2 can be pivotally connected to a pivot pin 32 of a conventional pipe connector 3 to substitute for the original locking lever of the pipe connector 3, enhancing the level of safety. Further, each pull ring slot 18 of the locking lever 1 has a narrow extension slot portion 181. The narrow extension slot portions 181 of the pull ring slots 18 prohibit the pull ring 17 from being turned accidentally. Therefore, the invention avoids accidental unlocking of the lock pin 15, assuring positive engagement between the lock pin 15 and the retaining plate 2.

A prototype of safety locking device for pipe connector has been constructed with the features of FIGS. 3˜10. The safety locking device for pipe connector functions smoothly to provide all of the features disclosed earlier.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A safety locking device pivotally connected to a pipe connector for locking a connection member inserted into said pipe connector, the safety locking device comprising:
a locking lever, said locking lever having a rounded engagement portion extended from a front end thereof for inserting into an opening on said pipe connector to lock said connection member to said pipe connector, a pivot hole transversely cut through said rounded engagement portion and pivotally connected to said pipe connector, a grip located on a rear end thereof, a protruding block integrally formed with an inner side of said grip, and a longitudinal through hole cut through top and bottom ends of said protruding block;
a retaining plate for stopping said locking lever in position after said connection member is locked to said pipe connector by said locking lever, said retaining plate having a top protrusion stopped against a part of said pipe connector, a bottom engagement portion, and a middle pivot hole pivotally connected with the pivot hole of said locking lever to said pipe connector;
a lock pin axially movably inserted into the longitudinal through hole of said locking lever, said lock pin having a front end extending out of the top end of said protruding block for engaging the bottom engagement portion of said retaining plate to prohibit said locking lever from turning relative to said pipe connector, and a bottom end extending out of the bottom end of said protruding block;
a spring member mounted in said longitudinal through hole of said locking lever and adapted to impart a pressure to said lock pin to force the front end of said lock pin into engagement with the bottom engagement portion of said retaining plate; and
a pull ring connected to the bottom end of said lock pin for a user to pull in order to retract said lock pin and to further disengage the said lock pin from the bottom engagement portion of said retaining plate.

2. The safety locking device as claimed in claim 1, wherein said locking lever further has a recess located on a bottom side of said protruding block, and two pull ring slots symmetrically disposed at two opposite lateral sides of said recess; and said pull ring has a part thereof inserted through said pull ring slots and coupled to the bottom end of said lock pin.

3. The safety locking device as claimed in claim 2, wherein each said pull ring slot has a rectangular portion and a narrow extension slot portion vertically upwardly extended from a top side of the rectangular portion for receiving said pull ring.

4. The safety locking device as claimed in claim 2, wherein said lock pin has a beveled front edge and an angled notch at one side of said beveled front edge for engagement with the bottom engagement portion of said retaining plate.

5. The safety locking device as claimed in claim 1, wherein said lock pin has a conical front tip and an angled notch at one side of said conical front tip for engagement with the bottom engagement portion of said retaining plate.

6. The safety locking device as claimed in claim 1, wherein said lock pin has a beveled front edge and an angled notch at one side of said beveled front edge for engagement with the bottom engagement portion of said retaining plate.

7. The safety locking device as claimed in claim 1, wherein said lock pin has a step near the front end thereof; said longitudinal through hole of said locking lever has a bottom end thereof fixedly mounted with a stop ring around said lock pin; and said spring member is sleeved onto said lock pin in said longitudinal through hole of said locking lever and stopped between the step of said lock pin and said stop ring.
